(19) United States
(12) Patent Application Publication
(10) Pub. No.: US 2007/0271590 A1
(43) Pub. Date: Nov. 22, 2007

(54) Method and system for detecting of errors within streaming audio/video data

(75) Inventors: Jonathan Gulas, Ottawa (CA); Tim Beckwith, Ottawa (CA); Michael Kelland, Ottawa (CA)

Correspondence Address: FREEDMAN & ASSOCIATES, 117 CENTREPOINTE DRIVE, SUITE 350, NEPEAN, ONTARIO, K2G 5X3, CA

(73) Assignee: Clarestow Corporation, Ottawa (CA)

(21) Appl. No.: 11/798,071

(22) Filed: May 10, 2007

Related U.S. Application Data
(60) Provisional application No. 60/799,467, filed on May 10, 2006.
(60) Provisional application No. 60/898,416, filed on Jan. 31, 2007.

(51) Int. Cl. H04N 7/173

(52) U.S. Cl. 725/118; 725/107; 725/126

(57) ABSTRACT

The rapid proliferation of streamed audio-visual services to users via the Internet, especially fee-based services, has increased the importance for content providers in establishing, maintaining, improving and validating the quality of service and experience they provide to the subscribers or users of their services. Accordingly, there is provided a method of determining quality metric data at the user's display in response to a provided digital multimedia stream. The quality metric data being stored for subsequent transmission to a remote server for aggregation and correlation with other quality metric data and defect related data of provided digital multimedia streams to provide service and network providers with quantified data relating to the quality of experience of users of Internet based audio-visual services. As such the quality metric data may be applied to discrete or continuous audio-visual content facilitating quality determinations for streamed content.

This application claims the benefit of U.S. Provisional Application No. 60/799,467, filed on May 10, 2006, and U.S. Provisional Application No. 60/898,416, filed on Jan. 31, 2007, the entire contents of both are incorporated herein by reference.

### FIELD OF THE INVENTION

The invention relates to detection of errors within streaming audio/video data and more particularly to the detection of errors within digital streaming media.

### BACKGROUND

With the advent of the Internet, a new set of challenges has confronted the communications industry. The Internet provides a network communication medium for communicating data at high speed from one location to another. Thus, the World Wide Web has grown in popularity and applications over the past decade. What was originally suited to delivering file data and image data via FTP, email, and HTTP, has grown to encompass music delivery, video delivery, and interactive application support.

A major concern in the implementation of interactive applications is the user experience. In fact, a user experience is the very essence of a value proposition offered by the interactive application. One hurdle in ensuring a quality user experience is the very network itself. The Internet is not designed to maximize quality of service. In fact, the Internet provides a robust network wherein quality of service is typically not guaranteed. For email, this is of little concern since a slowly delivered electronic message is still commonly much more efficient than manual delivery, for example by post. Similarly, for chat services wherein very small amounts of data are transmitted, quality of service issues are typically inconsequential since the small amounts of data are relatively efficiently delivered, as packetization thereof is unnecessary.

For transmitting music and video data via the Internet, common solutions provide for substantial buffering of the data prior to providing same to a user. This allows for clear delivery of songs, short video programs, and so forth. For longer video programming, the entire program is often downloaded before the video is displayed. Unfortunately, this is a solution poorly suited to providing Internet Protocol Radio (IP radio) and Internet Protocol TV (IP TV) wherein each has essentially open ended audio and video streams. It is therefore difficult to estimate the buffer requirements and, as such, ensuring of performance appears necessary to ensure functional IP TV or IP radio.

In the fields of packet-switched networks and computer networking, the traffic engineering term Quality of Service (QoS) refers to control mechanisms that can provide different priority to different users or data flows, or guarantee a certain level of performance to a data flow in accordance with requests from the application program. Such QoS guarantees are important if the network capacity is limited, especially for real-time streaming multimedia applications, for example voice over IP and IP TV, since these often require fixed bit rate and may be delay sensitive. Performance is a general term used for a measure of a quality of the experience that an end user or application “experiences.”

For interactive applications, the applications are typically designed to greatly reduce communicated data in order to reduce any problems of quality of service by providing small packet sizes. To support this, much of the rendering and processing is performed at the end user system since graphic manipulations and calculations are more predictably implementable than network communications of large amounts of data. Further, the data transmitted is typically as time insensitive as possible to ensure that performance issues do not affect the interactive application. However, for video delivery it is difficult to reduce the data bandwidth without affecting video quality. It is also difficult to ensure performance throughout a lengthy video event even with QoS, as packets are typically lost, delayed, and otherwise irretrievable during the event. The loss or delay of packet data has varied effects on the video event depending on frequency, content, encoding process, compression ratio, buffer size, and so forth.

Today, there are a series of QoS and performance monitoring solutions from a number of solution providers and technologies. A simple solution involves buffering sufficient data to ensure that QoS is not necessary for playback. For example, with a high speed Internet connection and for supporting video data near the full available bandwidth, buffering of half of the video data typically prevents performance issues from arising. For a two (2) hour movie, this requires a wait of over an hour before the movie commences. This latency is often considered unacceptable except for so-called “off-line” downloading wherein the subscriber pre-determines the content they wish and it is transferred during a predetermined intervening period prior to their access, such as during the middle of the night.

In another typical solution, monitoring nodes are inserted within the network to monitor network performance. The network is then tuned using QoS to result in a statistically deliverable performance for a set of customers. Unfortunately, tuning the network for some customers will result in reduced performance for others, an undesirable drawback. Along with network tuning, network performance upgrades must be implemented to stay ahead of ever increasing bandwidth requirements of subscriber applications. Thus an improving network infrastructure with tuning results can result in sufficient network performance for many applications. Unfortunately, this solution cannot adapt quickly to sudden changes in data traffic patterns. Further, though the solution ensures network performance it fails to ensure source and destination performance.

It would be advantageous to provide a method of evaluating delivered streaming audio/video performance that allows for flexible solutions to user perceived streaming audio/video quality of service issues.

### SUMMARY OF THE INVENTION

In accordance with the invention there is provided a method comprising:
providing a first system;
providing a digital multimedia stream including at least one of audio and video data to the first system;
providing information relating to the digital multimedia stream on the first system, the information in the form of at least one of audio and video presentation;
determining quality metric data relating to the display of the digital multimedia stream on the first system;
storing the quality metric data by the first system; and,
in response to a request from another system other than the first system, providing the quality metric data to a second system other than the first system.

In accordance with another embodiment of the invention there is provided a method comprising:
providing a first system;
providing a digital multimedia stream including at least one of audio and video data to the first system;
providing information relating to the digital multimedia stream on the first system, the information in the form of at least one of audio and video presentation;
determining quality metric data relating to the display of the digital multimedia stream on the first system; and,
transmitting the quality metric data from the first system to an aggregation server other than a system from which the digital multimedia stream was transmitted.

In accordance with another embodiment of the invention there is provided a method comprising:
providing a first system;
providing a digital multimedia stream including at least one of audio and video data to the first system;
providing information relating to the digital multimedia stream on the first system, the information in the form of at least one of audio and video presentation; and,
determining quality metric data relating to the display of the digital multimedia stream on the first system, the quality metric data related to user provided quality metric data, the user provided quality metric data provided for indicating an effect on a quality of a presentation in response to at least one of known problems with at least one of the first system and known errors within the data stream.

### BRIEF DESCRIPTION OF THE DRAWINGS

The invention will now be described with reference to the attached drawings in which:

FIG. 1 shows a simple communication network comprising a server, a first access point, a first communication hub, a second communication hub, a second access point and a workstation;

FIG. 2 shows another simple communication network comprising a server, a first access point, a first communication hub, a second communication hub, a third communication hub, a second access point and a workstation;

FIG. 3 shows a simple communication network comprising a server, a first access point, a first communication hub, a second communication hub, a third communication hub, a second access point and a workstation;

FIG. 4 is a simplified flow diagram of a method of evaluating a data stream for QoE to determine QoE metrics for use in automated analysis;

FIG. 5 is a simplified flow diagram of a method of evaluating scenes within a data stream for QoE to determine QoE metrics for use in automated analysis;

FIG. 6 is a simplified flow diagram of a method of evaluating and reporting on QoE as determined based upon an experience of an end user of a service;

FIG. 7 is a simplified architectural diagram of an architecture according to the invention;

FIG. 8 is a simplified architectural diagram of another architecture according to the invention;

FIG. 9 is a simplified architectural diagram of yet another architecture according to the invention;

FIG. 10 is a simplified flow diagram of a method of determining an effect of detected errors;

FIG. 11 is a simplified flow diagram of a simple streaming content application;

FIG. 12 is a simplified diagram of a method of forming a lookup table for evaluating a quality of streaming content;

FIG. 13 is a simplified diagram of a method of evaluating a quality of streaming content.

### DETAILED DESCRIPTION OF AN EMBODIMENT OF THE INVENTION

In the specification and claims that follow, the term QoE—Quality of Experience—is used to refer to a performance measure for streaming data relating to a quality of the end user “experience” with the data stream. An application that functions perfectly with a given stream performance would have a better QoE than an application that fails to function. Similarly, a user experience that is excellent would have a higher QoE than one that causes a consumer to complain, request a refund, or to be dissatisfied with the performance.

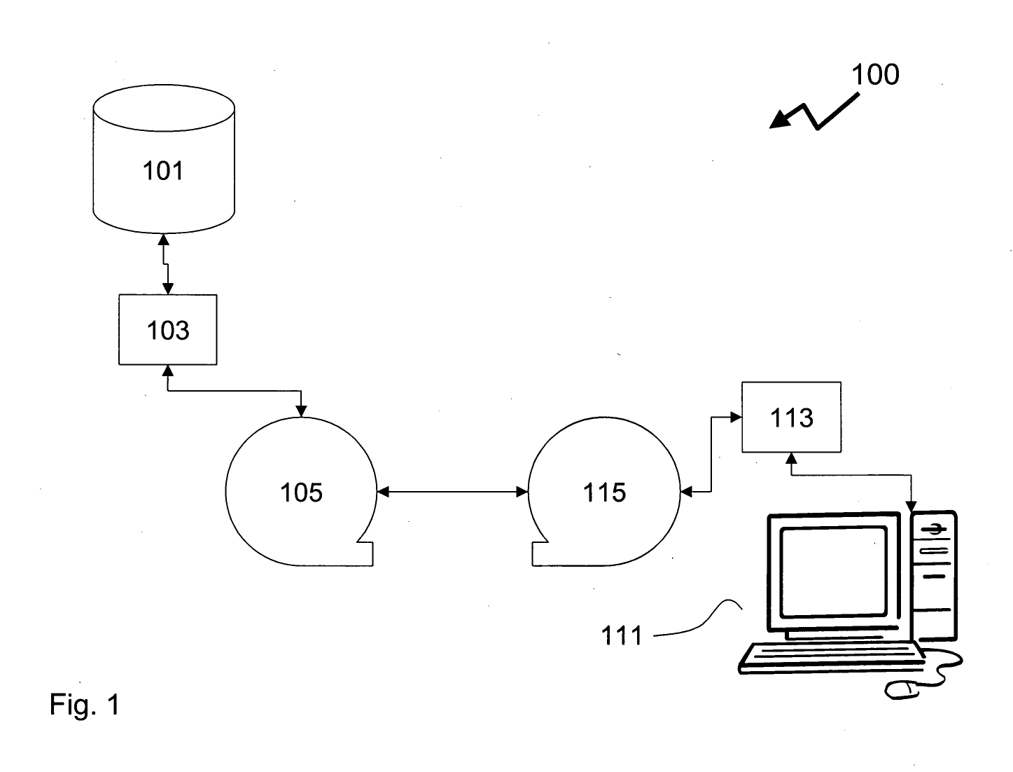

Referring to FIG. 1, a simple communication network 100 is shown comprising a server 101, a first access point 103, a first communication hub 105, a second communication hub 115, a second access point 113 and a workstation 111. The workstation 111 accesses data within the server 101 via the communication network 100. For example, the first and second access points are accessed via dial-up connections and the communication hubs are voice communication network offices. Here, since the communication network opens a dedicated channel between the workstation 111 and the server 101, a message transmitted from the workstation 111 to the server 101 is known to arrive at the server 101 with an approximately fixed delay. Thus, quality of service is known.

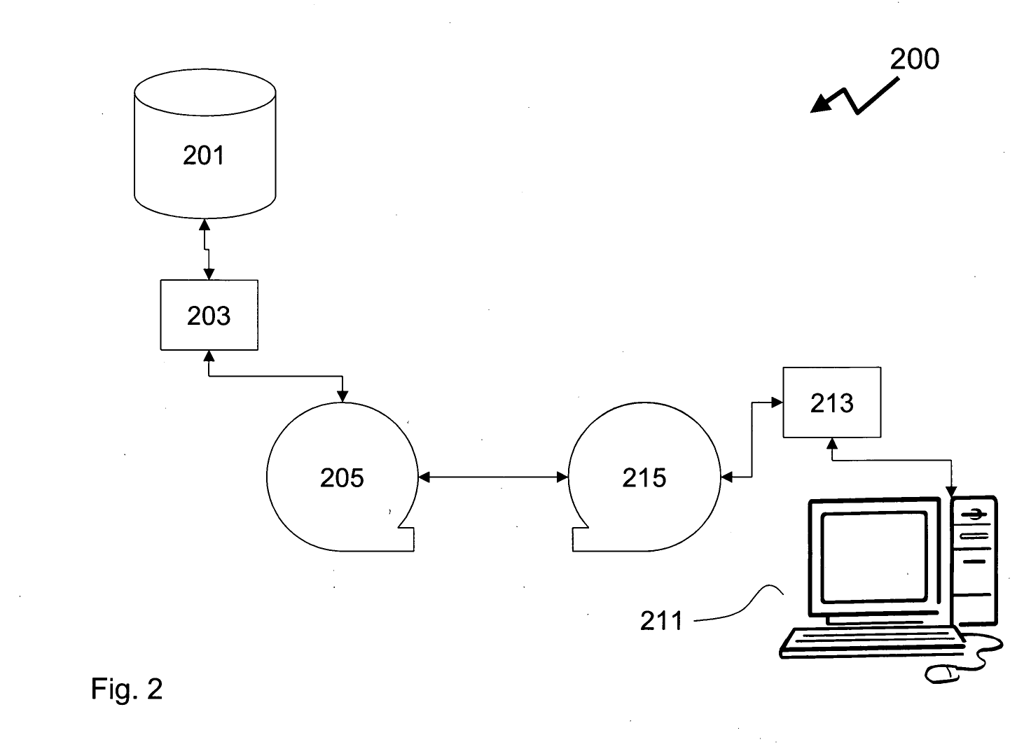

Referring to FIG. 2, shown is a wide area communication network 200 comprising a server 201, a first access point 203, a first communication hub 205, a second communication hub 215, a second access point 213 and a workstation 211. The workstation 211 accesses data within the server 201 via the communication network 200. Though the path for the data is not necessarily the path shown, it is shown as a simple path to facilitate understanding of the network behavior. Within the network there may be any number of servers, each coupled to an access point, or several servers may be optionally coupled to a same access point. Also within the network there are any number of communication hubs, workstations, and access points. A message transmitted via the network is known to proceed from a first system via an access point to another access point and to a destination system. That said, between the access points, the message traverses any of a large number of possible paths. Thus, a time between message transmission and receipt is unknown, as is the integrity of the message.

Today, the two most common approaches to QoE are network based monitoring with QoS and end-to-end systems. In network based monitoring, nodes are installed within a network and monitor network traffic, either real or test traffic. The monitored results are used with QoS for affecting the network by routing, tuning, upgrading, planning, and so forth. There are solutions that monitor and collect data within many different parts of a network that then interface with QoS to support improved network performance for a particular application. Unfortunately, performance and QoE are not always correlated, as such monitoring may simply be latency or bit-error rate determination for the packetized data.

In a paper entitled “Discerning User-Perceived Media Stream Quality Through Application-Layer Measurements,” Amy Czismar describes an experiment where she found that network performance and user experience were directly related and that determining an end user experience is not useful when network performance metrics are available. Thus, her experiment supports the current monitoring node methodology for ensuring performance. This is the current common understanding when it comes to performance issues and the Internet.

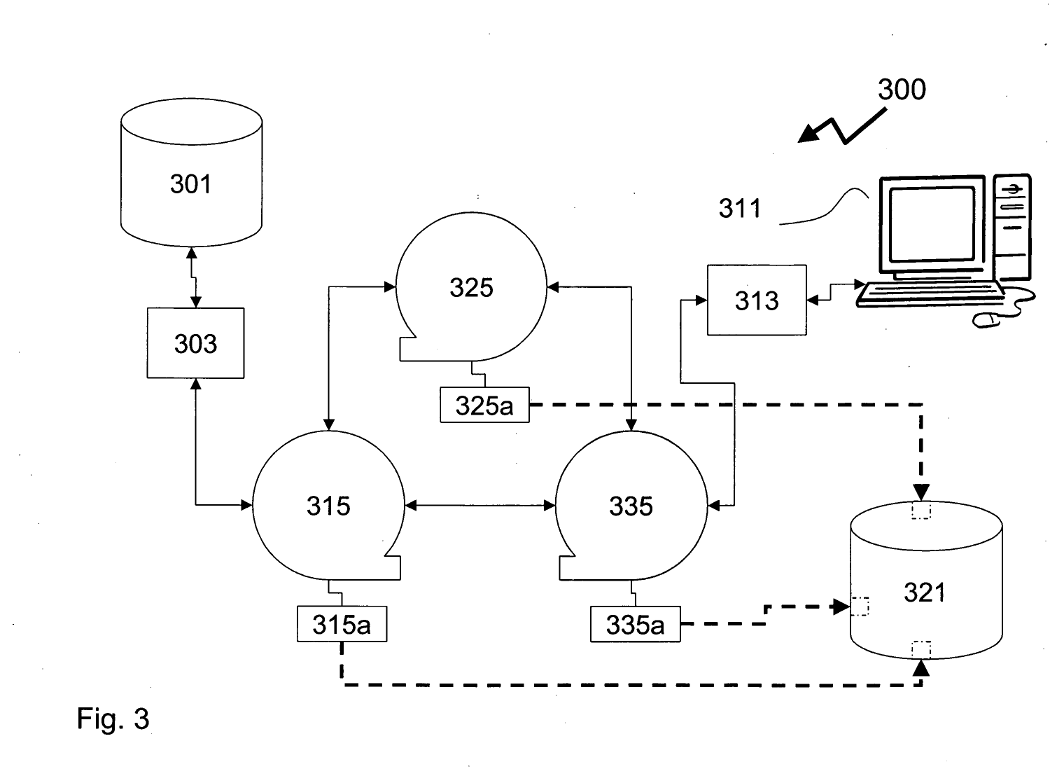

Referring to FIG. 3, shown is a simplified block diagram of an architecture supporting the commonly accepted methodology for ensuring network performance. Shown is a wide area communication network 300 which comprises a server 301 and a first access point 303 providing a high bandwidth connection to the network for the server 301. A first communication hub 315 within the network 300 is shown having a monitor 315a coupled thereto. A second communication hub 325 within the network 300 is shown having a monitor 325a coupled thereto. A third communication hub 335 within the network 300 is shown having a monitor 325a coupled thereto. Also shown is a second access point 313 and a workstation 311 coupled to the network 300 via the second access point 313. Shown are two separate paths between the first access point 303 and the second access point 313. It is understood, however, that many distinct paths exist between most pairs of access points.

An aggregation server 321 acts to aggregate performance metrics from the data provided from the monitors. The monitors are time synchronized to ensure accurate performance data. A predetermined packet is time stamped and provided for transmission from a first monitor 315a to a second monitor 325a within the network 300. The packet is analyzed when received to determine a transmission delay. By transmitting packets at known intervals between the same endpoints, it is possible to statistically evaluate performance within the network. Further, by sending data along different routes through the network, it is possible to determine relative differences in delay attributable to different routing.

Advantageously, when sufficient monitors are within the network 300, it is possible to use QoS within the network 300 to tune performance along a sub-set of the communication paths to improve network performance for a single packet, for a data set, or for the entire network. Further advantageously, tuning network performance results in improved performance across all video viewing experiences whether other solutions are in use or not. Unfortunately, there are many problems that are not addressed sufficiently in this approach without analyzing either performance at the workstation or at the server. Further, QoE is the true measure of customer satisfaction and, customer satisfaction is what most network providers and data providers seek. Network performance is merely an indicator of QoE; a measurement of QoE would be desirable.

Of course, such an approach does not address performance issues at either end of the communication path, be it-in the access points, the server or the workstation. Further, such an approach does not adequately support varied individual tastes. Yet further, such an approach fails to account for different data content having more or less sensitivity to network performance issues.

Another approach to improved network performance aiming to achieve sufficient QoE is the end-to-end solution model discussed with reference to FIG. 2. Here the network is treated as a black box. Video data in the form of video data is transmitted from the server 211 via the network 200 to the workstation 211. At the workstation 211, the video data is analyzed to determine feedback data for transmission to the server 201. By controlling the server and the workstation software applications, a data feedback loop is implemented wherein modification of at least one of the source video data, the path, and the control values provided to the network is performed in response to the feedback data. Thus, the end-to-end system is not concerned with network issues and seeks to provide a “best” performance to an end-user as determined via the feedback data.

Advantageously, the system corrects for issues arising within the server, the access points, and the workstation. For example, when performance is managed by managing bandwidth of data transmission, resource starving in the server results in all video data streams having reduced bandwidth—reduced overall quality—thereby alleviating the bandwidth problems of the server. Further, the end-to-end solution is “fair” in that all video data streams are treated similarly. In a situation where server resource starvation occurs, all users have their performance degraded similarly.

Unfortunately, neither the network based monitoring solution or the end-to-end solution support flexible, efficient, and customer centric performance issues. For example, even when a simple network tuning operation would enhance performance, the end-to-end system does not affect this simple solution. Further, if problems in performance persist, there is no effective trouble shooting other than to blame the network. Conversely in typical monitoring solutions, problems are typically diagnosable to the curb. When a monitor is inserted within a premise, it generally provides data relating to network health and status as opposed to focusing on end-user experience. If the problem persists, the only recourse is to blame at least one of the data provider and the end-user system. Unfortunately, for successful IPTV applications and other video-on-demand applications, customer satisfaction is crucial.

Another problem with end-to-end systems is that each audio/video stream is analyzed and treated similarly rather than being based on data type being displayed. As such, each and every stream is managed in concert to adjust performance as needed. Though this provides a best possible average performance, it does not result in a best overall performance since some streams are more prone to QoE issues than others. Also, when streaming video is received from numerous providers, execution of different end-to-end solutions renders the averaging of performance difficult. As such, providing stream-by-stream performance monitoring instead of system based performance monitoring would be highly advantageous.

A known solution to some of the problems is to provide a set top box. A set top box as used herein is a closed system for forming an end-point for multimedia data for display on a monitor or television. Because the set-top box is part of a closed system, typically a CATV network, there is a single data provider and resource starving cannot occur at the set-top box. As such, some of the above problems are alleviated. Unfortunately, set-top boxes that are specific to a data provider and fixed installations are not considered desirable. Today, people want to watch video on their desktop or laptop computers with all the benefits of the computer.

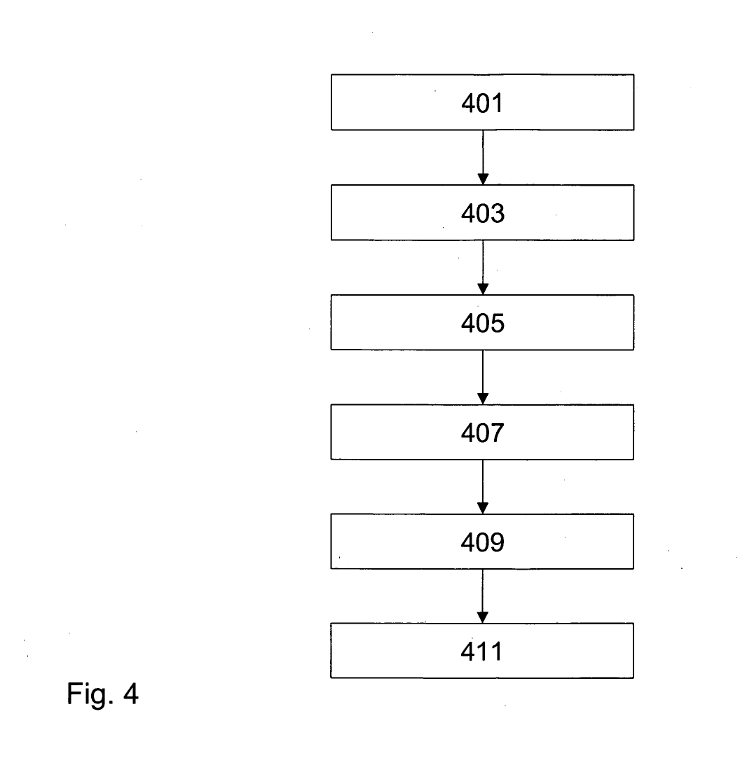

Shown in FIG. 4 is a simplified flow diagram of a method of evaluating QoE for reporting thereof. A stream of video data is provided at step 401. The video data is then used to generate a presentation on a workstation at step 403, the presentation generated with known defects relating to known causes of presentation quality reduction.

For example, the workstation may be resource starved in a simulated manner or in reality by executing a predetermined resource intensive application within the workstation. The presentation is then evaluated by a user of the workstation to determine a QoE measure for the presentation. Then, the same presentation is provided (possibly on another workstation) with other causes of defects including at least one of the following: missing data from the data stream, delays in data reception within the data stream, errors in data within the data stream, starvation of resources within the workstation, over usage of the workstation, starvation of resources within the server, over usage of the server, delays in messaging, insufficient resources on the server, and insufficient resources on the workstation. Further, the degree to which each of the causes of defects is provided may additionally varied. Each presentation is then evaluated by a user to determine a QoE at step 405. Optionally, each presentation is evaluated by several users to determine a statistical QoE.

The QoE data is then determined based on the user data provided and the errors that occur during presentation at step 407. Errors are determinable on several levels, bit errors, errors in the generated presentation, and problems with user experience, and each is reportable. That said, hereinbelow there is considerable focus on degradation of user experience as a measure of “error.” For a given set of occurring errors, a QoE determination is made. Thus, if QoE is rated as “acceptable” for a set of errors that occur with a known timing window, then that set of errors with that particular timing is not substantially significant. Alternatively, when QoE is rated as “poor” for a set of errors that occur with a known timing, that set of errors with that timing is substantially significant. From the different results, statistical data is determined at step 409 for use in mapping errors occurring during presentation onto the measure of QoE. At step 411, the statistical data is stored.

In another embodiment, raw error data is determined and then mapped onto a representation of a media entity to provide an indication of degradation in that rendered media entity. This representation is then analyzed to determine a QoE for the rendered media—for example for video good viewing or poor viewing

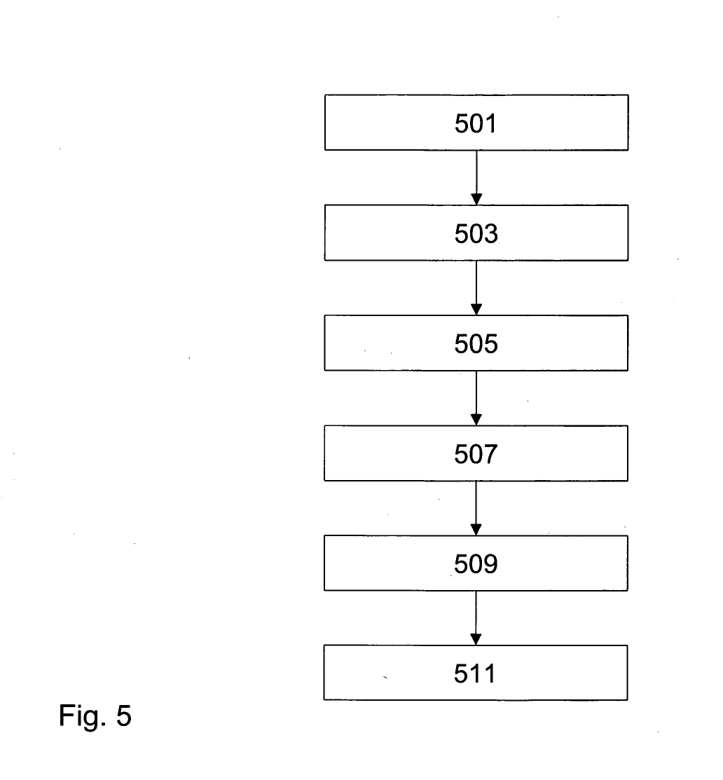

Shown in FIG. 5 is a simplified flow diagram of a method of evaluating QoE for reporting thereof. A video stream having a plurality of different scenes is provided at step 501. Each scene has known characteristics that are determinable through automated data analysis. The video data is then used to generate a presentation on a workstation at step 503, the presentation generated with known defects relating to known causes of presentation quality reduction.

For example, the workstation is resource starved by executing a resource intensive application within the workstation. Scenes within the presentation are then evaluated by a user of the workstation to determine a QoE measure for the scenes. Then, a same presentation is provided (possibly on another workstation) with other causes of defects including at least one of the following: missing data from the data stream, delays in data reception within the data stream, errors in data within the data stream, starvation of resources within the workstation, over usage of the workstation, starvation of resources within the server, over usage of the server, delays in messaging, insufficient resources on the server, and insufficient resources on the workstation.

Further, the degree to which each of the causes of defects is provided is variable. Each scene is evaluated by a user to determine a QoE at step 505. Optionally, each scene is evaluated by several users to determine a QoE.

The QoE data is then determined at step 507 based on the user data provided and the errors that occur during presentation. For a given set of occurring errors, a QoE determination is made. Thus, if QoE is rated as “acceptable” for a set of errors that occur with a known timing, that set of errors with that timing is not substantially significant. Alternatively, when QoE is rated as “poor” for a set of errors that occur with a known timing, that set of errors with that timing is substantially significant. From the different results, statistical data is determined at step 509 for use in mapping errors occurring during a presentation and content analysis onto a measure of QoE. The statistical data is then stored at step 511.

Alternatively, QoE is determined analytically. For example, an error threshold is provided above which QoE is considered poor. Optionally, the threshold is modified in dependence upon presentation content. For example for harmonious audio a lower error threshold is acceptable whereas for audio that is severely inharmonious—explosions for example—a higher error threshold is possible. Preferably, the thresholds are used statistically with error duration, density or interval, type, and presentation type and location to determine a QoE measure.

Once QoE metrics have been determined, for example using the method of FIG. 4 or FIG. 5, the QoE metrics are stored for later application to streaming multimedia data.

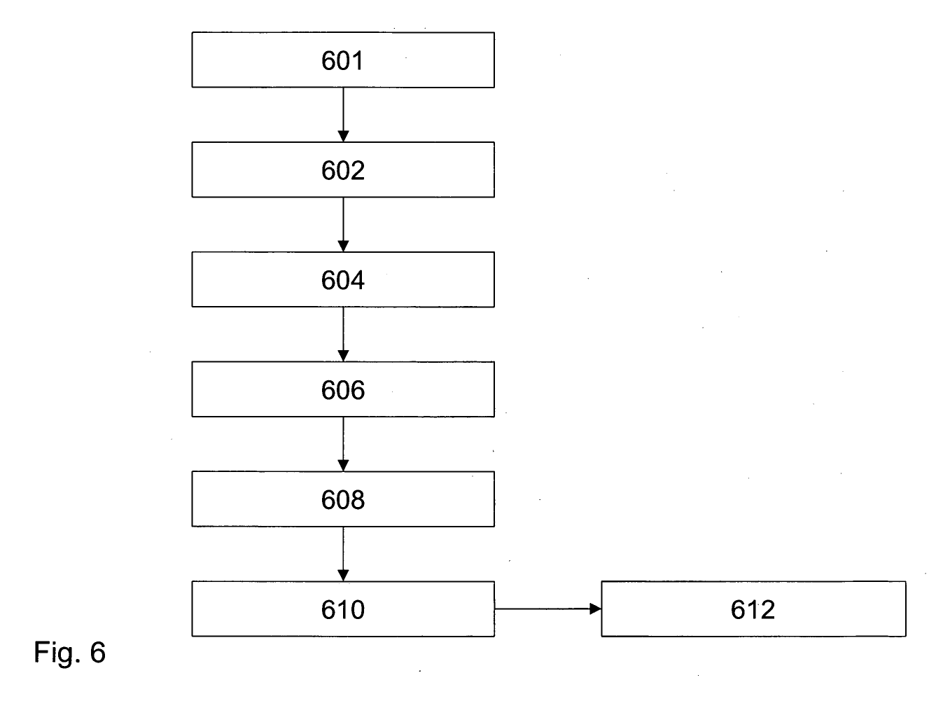

Referring to FIG. 6, shown is a simplified flow diagram of a method of evaluating and reporting on QoE as determined based upon an experience of an end user of a service. The description hereinbelow is given in relation to streaming video though the method works with other forms of video and audio data delivery.

At step 601, a signal is provided from a workstation to a server to initiate a stream of data therefrom. At step 602, the stream of data is transmitted from the server to the workstation in a packetized fashion. At step 604 the packets are received at the workstation and as best possible the data stream is reconstructed. At step 606, the reconstructed data stream is provided to a media player for presentation to an end user therefrom. The media player includes a plug in QoE evaluation process—a software process additional thereto—or alternatively has a QoE evaluation process integrated therein. At step 608, the QoE evaluation process analyses the data stream to identify errors within the data stream. These errors typically relate to errors detectable through a use of error detection codes such as checksums, hashes, etc. For example, errors optionally include frame rate errors, pixel errors, errors resulting from buffer starvation and lost packets. One of skill in the art of error detection and error correction coding will understand that many different codes are applicable for the recited purpose. At step 610, the QoE evaluation process evaluates the presentation to determine a quality metric in relation thereto. This quality metric is a metric relating the actual complete data stream and the presented data. Thus, for example, if the data stream has many errors and the presentation is an accurate reflection of the erroneous data stream, a quality metric is based on the error content of the data stream. Alternatively, when the presentation is poorly correlated with the data stream, the quality metric is based on error content of the data stream and differences between the data stream content and the presentation. Thus, a QoE metric relating to data presentation is provided.

When data integrity is essential, an indication of an error causes the system to indicate a data stream error and cease operation upon the data. Of course, it is well known that for audio and video data, an error does not typically render the information unusable but sometimes results in errors in display or play-back of the audio-visual data.

Referring again to FIG. 6, it is possible to evaluate from a received data stream and a presentation based thereon a QoE metric for said data stream independent of a cause of stream data errors. Further, it is possible to attribute different QoE metrics to system performance based issues based on the analysis. Advantageously, the QoE metrics relate to real world QoE and may be correlated to detected issues within a data stream. The resulting QoE metrics are then stored at 612 for later provision to a requesting system. Alternatively, the resulting QoE metrics are provided to an aggregation server for provision therefrom. Further alternatively, the QoE metric data is provided to several different systems for use in improving a determined QoE.

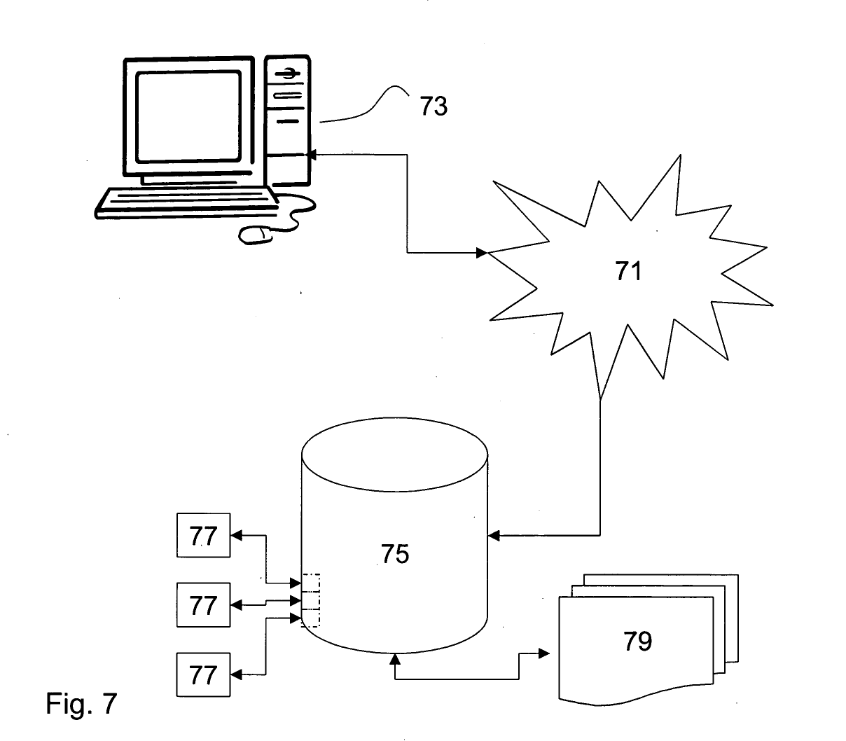

Referring to FIG. 7, shown is a simplified architectural overview of an exemplary network and process for performing a process according to the invention. The simplified architecture shown operates in accordance with existing standards. It will be evident to one of skill in the art that as standards change, new or different architectures may be beneficial.

A client agent is installed for execution on a workstation 73 in communication with a plurality of servers, not shown for clarity, via a network 71. When the workstation 73 receives a data stream suitable for analysis and reporting according to this embodiment from a service or content provider, the client agent active upon the workstation 73 determines and reports quality metric data to an aggregation server 75. Optionally, the aggregation server 75 also polls workstations to receive instantaneous quality metric data status for use in addressing needs of customer support such as help desk calls. Here data is routed through fast message switching on the aggregation server to various monitoring and alerting interfaces 77 as well as to persistent data storage 79 for historical, trend and support uses.

Advantageously, such a system is standards-based in order to function easily within existing infrastructures. Further, the described architecture is implementable with low-impact on the workstation 73 and on the network 71. Further advantageously, the architecture supports a secure implementation of the agent and of the aggregation server 75, and one which is highly scalable. For example, by associating different service providers with different aggregation servers, it is possible to distribute the communication load, the security load, the storage load, and the processing load between multiple systems.

Advantageously, the exemplary architecture meets and/or relies on standards for implementation within current networks. Alternatively, the architecture need not meet these standards for implementation on other networks including future networks. For example, the workstation and agent are designed to meet J2SE/J2ME standards, thereby allowing the agent to be ported between different operating systems and different hardware platforms such as desktop PC's, set top boxes and mobile devices. Alternatively, the agent does not conform to the J2SE/J2ME standards. The aggregation server 75 may be designed to meet one or more of the following standards: IPDR, SNMPv3, SOAP-XML, and HTML. These standards allow for interoperability enhancement via many available products. Alternatively the aggregation server meets only some of or none of the standards listed supra.

In the architecture of FIG. 7, it is preferred that communication overhead be low so as to have limited impact on communication efficiency and effectiveness of each workstation, and limit additional network overhead. Thus data relating to QoE that is being aggregated, namely the quality metrics data, is transported over the network using a custom low impact protocol. Alternatively another protocol may be used.

The custom low impact protocol comprises two parts. A first part supports so-called “push” based communications—namely communications initiated by the sender of the data to be transmitted. This protocol pushes quality metrics data from the workstation 73 to the aggregation server 75 in response to a change in QoE. Thus a packet is only transmitted on stream start and end and when there is a material change in QoE. Additional packets are optionally transmitted in response to specific events such as an advertisement view, a scene change, and a stream change. Each packet from a same workstation 73 is tagged with a unique id for reconstruction purposes, and includes information in a compressed form about the QoE—quality metric data, resource level on the client device and other relevant data. A second part of the low impact protocol supports so-called “pull” based communications—namely communications initiated by the recipient of the data to be transmitted. This protocol is initiated by an administrative system to request information from a particular client, group of clients, or from the aggregation server. This is beneficial in, for example, a helpdesk call situation. The pull protocol is implemented with UPnP standard to execute pulls from active clients that are behind gateways, such as home routers. Alternatively, another pull protocol may be used.

In the architecture shown, security is provided to support a secure client agent that is not easily tampered with. This is achieved by limited remote access to the client agent, securing communications from the client agent, limiting data collected and transmitted by the client agent, and by limiting communication of data to predetermined aggregation servers. By limiting communication to a known type of aggregation server, security processes are implementable, testable, and verifiable. Further, the data collected by the client agent is related to anonymous usage statistics when possible such that access thereto is of little use to others and hence of minor consequence. Alternatively, security is provided outside of the architecture of the QoE system. Further alternatively, no security is provided.

Similar security features are desirable for the aggregation server, including but not limited to, ensuring that the aggregation server is not exploited remotely, or is not manipulated by intentionally misleading or improperly formatted data, making the aggregation server isolated such that a breach of the aggregation server will not enable an attacker to gain entry to any other systems, and providing secure output ports of the aggregation server such that they are safe for interfacing with other systems regardless of the data received at input ports thereof. Alternatively, security is provided outside of the architecture of the QoE system. Further alternatively, no security is provided.

The architecture described with reference to FIG. 7 is particularly suitable to meet the scalability requirements of today's Internet. Further it supports upgrade of the system and allows an efficient scaling of services. For example distributed architectures such as J2EE and techniques gleaned from grid-based systems such as Oracle's RACS and the Luster file system are useful tools in supporting scalability. Alternatively, scalability is not supported.

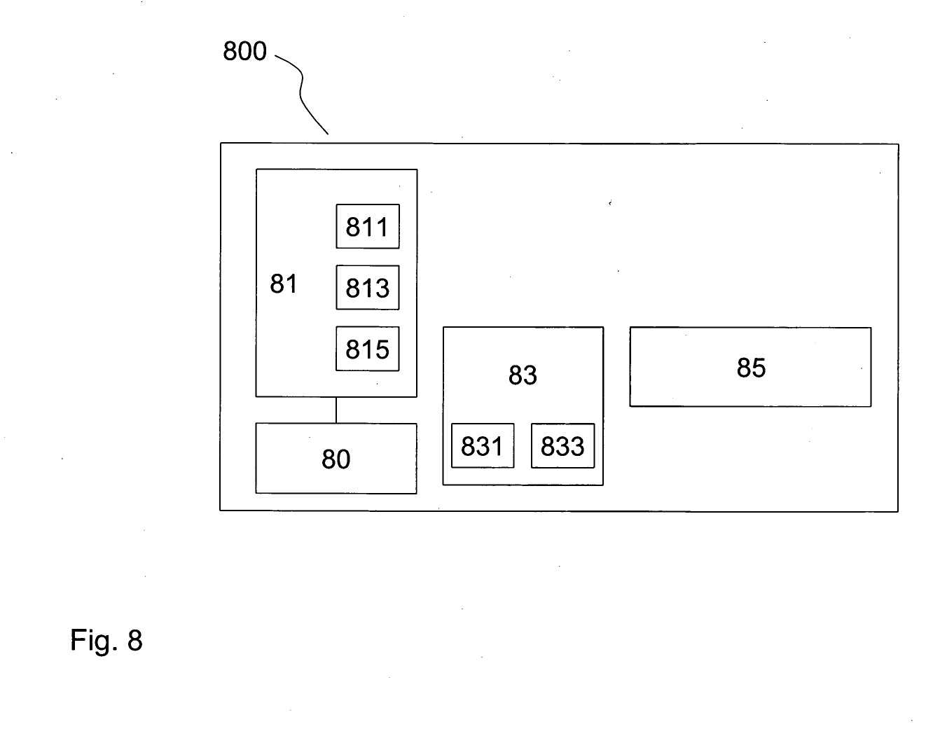

Referring to FIG. 8, a simplified block diagram of an architecture of the client system 800 is shown comprising three (3) major components—a media player plug-in component 81; a core agent 83 including the Experience MUX 831 and Communications component 833, and a system load monitor 85. The media player plug-in component 81 interfaces with a standard media player 80 that supports intermediate plug-ins such as DSP-style plug-ins. Alternatively, the media player plug-in 81 is for interfacing with a media player 80 having an interface for interfacing with the plug-in 81. Alternatively, the media player plug-in 81 comprises the media player 80.

Existing media players present multi-media information following a process. The typical process is as follows:
1. The media player receives the content via a source;
2. The media player buffers the content as required—a streaming video requires more buffering than a DVD for instance;
3. The media player decodes the content using input plug-ins referred to as codec's;
4. The media player passes the content to any intermediate plug-ins, for example a DSP plug-in for the Windows® Mediaplayer, currently installed and active through an input buffer;
5. The intermediate plug-ins modify the content and provide the modified content to an output buffer; and
6. The media player renders the content in the output buffer for presentation.

The client agent 81 includes three (3) processes, for example these are developed in Java® to provide cross platform functionality. The processes comprise:

1. input process 811 which identifies the source of the stream and various data about the encoding and input data conditions of the stream;

2. DSP process 813 which includes a quality metric data assessment and analysis process; and

3. output process 815 which returns information to a client via an overlay on a window of the media player 80 in order to provide feedback information or to assess a user's quality of experience.

The core agent 83, for example similarly developed in Java®, handles communication with the aggregation server and consolidates data relating to the QoE and the current system state. This data is then analyzed to determine what data is to be transmitted to the aggregation server. The core agent 83 also receives and handles pull requests from the aggregation server and polls system state as required.

In the present embodiment, the quality metrics data is determined based on user experience data provided in accordance with a process such as those outlined with reference to FIGS. 4 and 5. Alternatively, another method of determining quality metrics data is employed. The core agent 83 correlates quality metrics data with data relating to the data stream and system performance to determine data relevant to Packet Loss, Latency, Jitter, throughput, system starvation, resource shortages, and so forth. The quality metrics data is based on analysis of presentation at the application layer—as close to the user experience as possible. Thus real world user feedback is used to determine quality metrics data. Alternatively, analysis of the presentation data is performed to determine quality metrics data.

The system load monitor 85 surveys a current system state to determine performance issues. The system load monitor 85 polls information such as system resource data relating to the CPU, RAM, storage media, communication ports, and so forth to determine load based issues that affect the quality metrics data. Output data from the system load monitor 85 is then used by the Core Agent 83 for correlating with quality metrics data to identify potential issues in need of attention. Thus, the client agent provides for local monitoring of the user experience based on data stream integrity, timing, reconstruction, and local system load related issues.

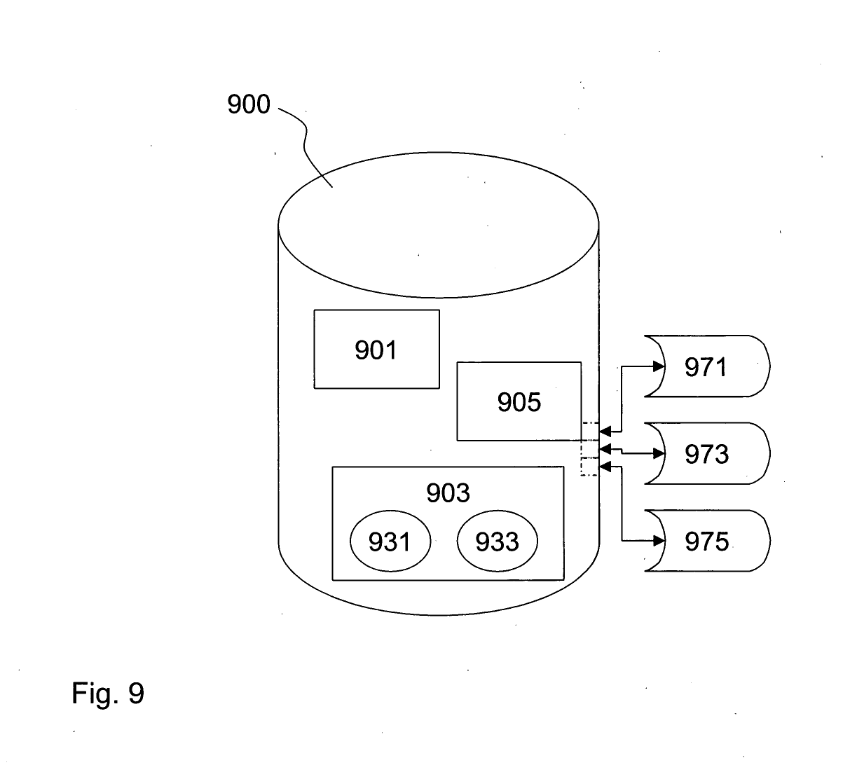

Referring to FIG. 9 the architecture of an aggregation server 900 is shown. The aggregation server 900 is for receiving data from all client agents on workstations wherein users are currently viewing streamed media. The aggregation server 900 relies upon pre-configured quality thresholds in combination with data provided from the client agent to determine a consequence of a client's current quality metrics data. For example, can a deviation from the client's previous quality metrics data be rectified through dynamic re-allocation of resources. The aggregation server 900 also logs data within a large database for later analysis. In this way, the aggregation server 900 provides both synchronous and asynchronous feedback to service providers.

If current quality metrics data is improved by a course of action, the aggregation server 900 instructs existing mechanisms to perform this course of action, for example to modify an allocation, change the codec or otherwise change delivery of content. Alternatively, automated mechanisms directed by the aggregation server 900 are not implemented and mechanisms are manually adjusted. Further alternatively, automated mechanisms directed by the aggregation server 900 are not implemented and mechanisms are automatically adjusted by a system of the service provider.

The aggregation server 900 is implementable as a system capable of spanning several disparate servers in multiple locations that make determinations possible both in a local and in a distributed manner. Alternatively, the aggregation server 900 is implemented for local application within a single system.

The aggregation server 900 comprises the following components: communication block 901 including input message, output message, and message switching; persistent storage 903 including data management 931 with mirroring and backup 933; a management block 905 including reporting and configuration; and remote interfaces including programmatic APIs 971, alerting function 973 and standard communication interfaces 975.

The aggregation server 900 accepts many client connections and routes these appropriately. Data is routed through to both persistent data storage and real time eventing. The persistent data storage is optionally extremely thin, transferring raw data to a database, which may then be replicated to a mirror for backup and analysis, thereby removing load from the primary application. The real time event handler reassembles relevant messages into sessions and uses these along with configured thresholds to trigger events such as IPDR messages and external interface signals. Optionally, events and signals are not triggered by the aggregation server 900 and are generated by applications retrieving data from the aggregation server 900.

The aggregation server 900 has a management console, not shown for clarity, which is for example accessible over HTTP and allows customers to configure their service and retrieve reports and data. The management console allows grouping of clients based on various criteria and near-real time views of the quality metrics data. From the console, administrators can request pull data relating to clients or groups of clients.

Alternatively, instead of determining a QoE measure at a workstation, the QoE is analyzed and determined at the aggregation server 900 based on quality data provided to the aggregation server. For example, thresholding and statistical analysis of the quality data is performed at the aggregation server.

Alternatively, instead of relying on user provided QoE metric data for analyzing data streams, harmonicity and other factors relevant to human perception are used analytically to evaluate stream content independent of real world user experience data being provided to the system directly.

In an embodiment, the system communicates directly with a user of the workstation to allow them to adjust resources to improve their experience—such as allocating increased CPU or memory to the media player. Alternatively, this adjustment of resources is performed automatically. Further alternatively, it is performed automatically only when a user specifies such as a preference.

In a further alternative embodiment, adaptive streaming is supported to alternately throttle or increase bandwidth from the server to eliminate clients having to select a bandwidth level on media start up. Thus, the system calibrates itself to determine an optimal or near optimal bandwidth based on real world bandwidth considerations.

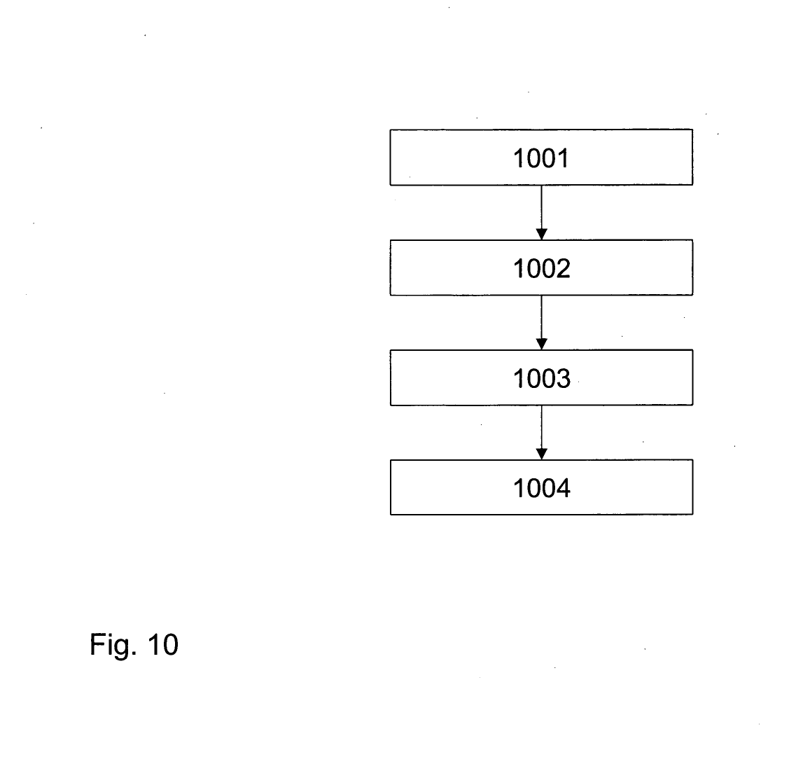

Referring to FIG. 10, a simplified flow diagram of a method of determining an effect of detected errors is presented. Here, errors when detected are identified and compiled at step 1001. The identified errors are then mapped at step 1002. At step 1003, for each error, an analysis of the data within the data stream and about the error and within which the error is located is performed. The analysis is for determining for the data a perceptibility of the error when the data is utilized. For example, for a data stream a location of the error within a word and number of errors within a same passage of music are evaluated to determine an effect of the errors, either in correlation with predetermined data or through independent analysis against characteristics of the medium content. For example, it is known that with audio data, a lack of harmonicity results in a lower sensitivity to data error. As such, errors within segments of audio data that are inharmonious are less significant than those that occur within highly harmonious segments of audio data. As such, an analysis of audio data determines a likely significance of erroneous data or damage to the optical storage medium. Preferably, detected errors are then reported at step 1004 based on the analysis and the detection of errors to provide data relating to a significance of the errors detected. Similar analysis is possible for video data and for other types of data within the optical storage medium. For example, analysis of focus, clarity and contrast in video images helps to determine an importance of an error, wherein unfocused portions are less susceptible to errors affecting a user experience and more focused portions are more prone to errors being noticeable. Advantageously, some of the analysis can be done in advance to alleviate processing times for verifying data stream contents. In combination, analysis is performed as necessary on unrecognized data streams for which mapping data is unavailable. Further, the process supports improvements to analysis processes and custom analysis processes when used.

Though the above is described with reference to particular aspects of technology, it is also useful in application. For example, when streaming content is paid for, verification of a QoE measure of a user experience is important prior to crediting a user for a poor quality experience or providing the same user with a free repeat experience.

Streaming video varies in quality based on server load, link speeds, activity on a displaying system, configuration of a displaying system, network topology, noise, and network traffic related issues. Further, video quality, such as that of the original data, and other factors also affect the human experience of enjoying streaming audio and streaming video.

Though all of the above is true, many users of the Internet today listen to streaming audio similar to listening to a radio station. Also, many users watch streaming videos. Unfortunately, there is presently no real way to evaluate a quality of streaming video or audio provided.

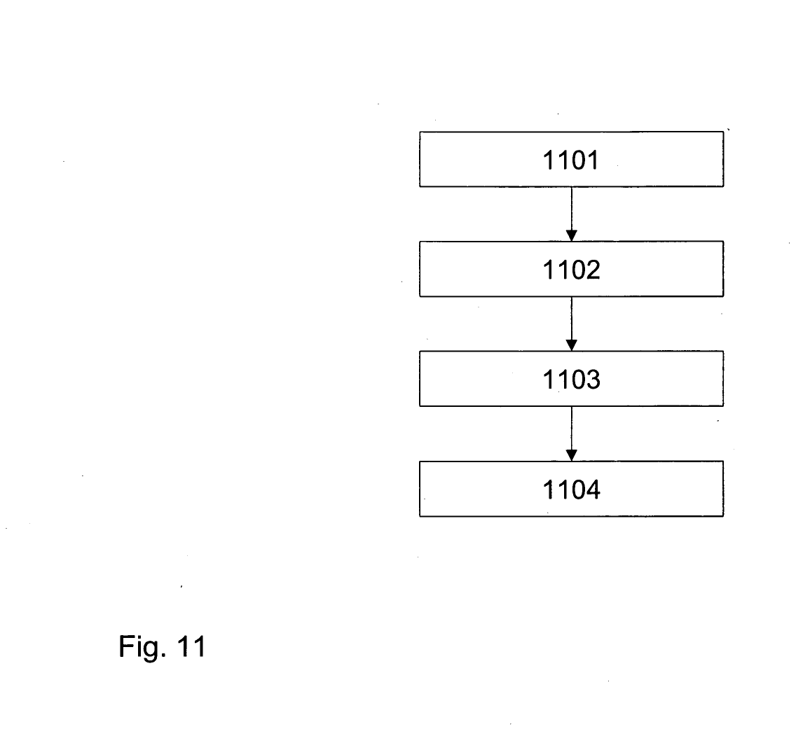

Referring to FIG. 11, shown is a simplified flow diagram of a simple streaming content application. At step 1101 a server is contacted to provide streaming content. At step 1102, the server sets up a thread to deliver the streaming content to the requesting system. At step 1103 the content is transmitted via the Internet to the receiving system and at step 1104 the receiving system begins to play the streaming content while it is still receiving same. Common errors result from buffer under run conditions and from buffer over run conditions. In each case, insufficient data is present to render the streaming video as recorded.

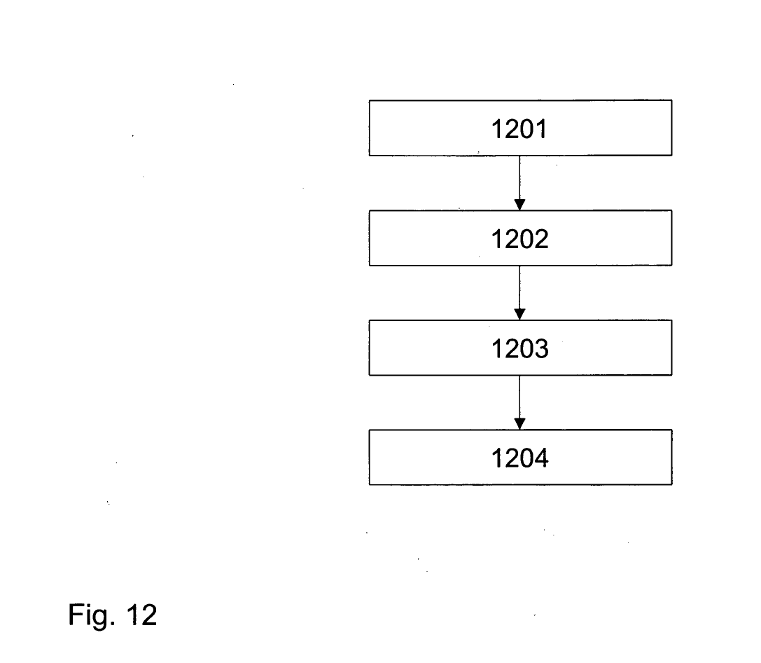

Referring to FIG. 12, shown is a simplified diagram of a method of forming a lookup table for evaluating a quality of streaming content. At step 1201, a known content file is streamed to a display system from an available local server. The display system is variably loaded and human experience data relating to the streamed content is provided. The human experience data is stored in association with the load.

At step 1202, a load is applied to the local server. The load is varied and human experience data is provided relative to the streaming content and stored in association with the varied load. Optionally, the steps 1201 and 1202 are performed together to form a table relating server load, display system load and user experience. At step 1203, a network traffic delay is evaluated relative to human experience. At step 1204 the human experience data is compiled into a table for use in evaluating streaming content.

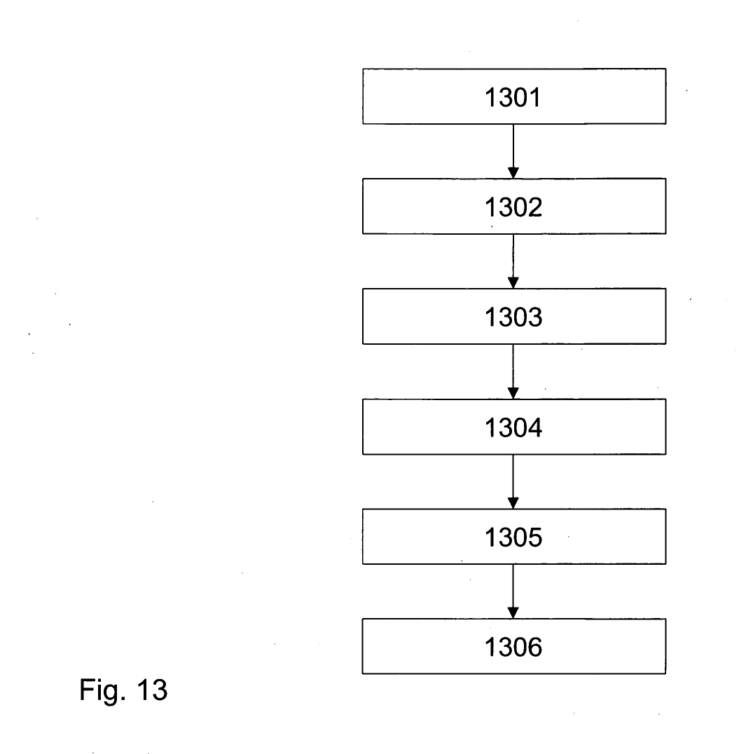

Referring to FIG. 13, shown is a simplified diagram of a method of evaluating a quality of streaming content. At step 1301, a content file is selected for streaming to a display system. At step 1302, the display system is evaluated for a load thereon. At step 1303, the server is evaluated for a load thereon. At step 1304, network traffic is evaluated for any delay. At step 1305, the resulting data is provided to the server where it is used to determine from the lookup table a human experience quality. At step 1306, the human experience quality is then used to determine modifications that are available on one of the server and the display system to improve user experience. For example, a display system load is reduced. Alternatively, a smaller file having lower resolution is streamed. Further alternatively, the buffer on the display system is increased such that more of the data is received prior to commencing provision of the streaming content. Of course, link speed at both a server and the display system are important factors in the analysis.

Alternatively, the user experience is gathered as the streaming content is provided—for example a poll is conducted—and parameters are adjusted to improve streaming content quality. Preferably, whether a lookup table is used or user experience is provided directly, data is gathered on user experience for use in commencing a streaming event in a most suitable estimated fashion.

Of course, methods of evaluating content quality in an automated fashion such as relying on harmonicity of audio and focus or contrast of video are also useful in order to automate the process obviating human input of the human experience data. Also, network analysis to determine sources of latency within the network and mechanisms for addressing same is performable. Optionally, no network analysis is performed and latency is assumed to be approximately constant.

Using the above described method, a method of adaptive streaming is supported wherein the feedback data forms a feedback path to a server and wherein the server and/or display system parameters are modified during streaming content delivery, for example to alternately throttle or increase bandwidth from the server. Of course, other parameters are also addressable in a dynamic and adaptive fashion.

Alternatively, the methods disclosed herein are applied to multi digital asset management functions such as creating virtual libraries and converting electronic file formats to optical media storage or streaming content and verifying the quality.

Alternatively, the process described herein is used to iteratively adjust parameters within a network providing streaming data and then analyzing an effect of the adjustment to tune the network. Advantageously, adjustment and analysis is performable at many points within the network in concert such that adjustments can accommodate many user systems and many servers simultaneously.

Alternatively, a user of the workstation on which a presentation is being executed is able to “complain” by selecting a complain option. In response to the complain option, data is pushed to one of the aggregation server and a service provider server for immediate attention. Further alternatively, in response to a quality metric below a predetermined threshold, data is pushed to one of the aggregation server and a service provider server for immediate attention without requiring the users input.

Numerous embodiments of the invention will be apparent to one of skill in the art without departing from the spirit and scope of the invention.

What is claimed is:

1. A method comprising:
providing a first system;
providing a digital multimedia stream including at least one of audio and video data to the first system;
providing information relating to the digital multimedia stream on the first system, the information in the form of at least one of audio and video presentation;
determining quality metric data relating to the display of the digital multimedia stream on the first system;
storing the quality metric data by the first system; and,
in response to a request from another system other than the first system, providing the quality metric data to a second system other than the first system.

2. A method according to claim 1 wherein the another system comprises the second system.

3. A method according to claim 1 wherein the quality metric data is stored within the first system.

4. A method according to claim 1 wherein the quality metric data is provided from the first system.

6. A method according to claim 1 wherein the quality metric data comprises a measure of the quality of experience (QoE) of a user experiencing the presentation.

7. A method according to claim 6 comprising:
providing mapping data indicative of a level of defect sensitivity of QoE for the data stream when presented;
determining defects within the data stream when presented; and,
mapping the detected defects to determine a QoE measure for the data stream.

8. A method according to claim 7 wherein determining comprises determining during data stream presentation a number and classification of defects occurring during the presentation whether present within the received data stream or having other causes.

9. A method according to claim 8 wherein the mapping data is formed by statistically correlating user evaluation data relating to viewing of data streams on a plurality of systems, at least one of the systems and the data streams having known causes of defects within presented audio/video experiences.

10. A method comprising:
providing a first system;
providing a digital multimedia stream including at least one of audio and video data to the first system;
providing information relating to the digital multimedia stream on the first system, the information in the form of at least one of audio and video presentation;
determining quality metric data relating to the display of the digital multimedia stream on the first system; and,
transmitting the quality metric data from the first system to an aggregation server other than a system from which the digital multimedia stream was transmitted.

11. A method according to claim 10 comprising:
storing the quality metric data within the aggregation server.

12. A method according to claim 10 wherein the aggregation server comprises a process for alerting the system from which the digital multimedia stream was transmitted in response to a problem highlighted by received quality metric data.

13. A method according to claim 10 wherein the quality metric data is stored within the first system.

14. A method according to claim 10 wherein the quality metric data is provided from the first system.

15. A method according to claim 10 comprising:
determining performance metrics for at least one of the first system; and,
providing the performance metrics to the aggregation server.

16. A method according to claim 10 comprising:
determining performance metrics for a system from which the digital multimedia stream was transmitted; and,
providing the performance metrics to the aggregation server.

17. A method according to claim 10 wherein the quality metric data comprises a measure of the quality of experience (QoE) of a user experiencing the presentation.

18. A method according to claim 17 comprising:
providing mapping data indicative of a level of defect sensitivity of QoE for the data stream when presented;
determining defects within the data stream when presented; and
mapping the detected defects to determine a QoE measure for the data stream.

19. A method according to claim 18 wherein determining comprises determining during data stream presentation a number and classification of defects occurring during the presentation whether present within the received data stream or having other causes.

20. A method according to claim 19 wherein the mapping data is formed by statistically correlating user evaluation data relating to viewing of data streams on systems, at least one of the systems and the data streams having known causes of defects within presented audio/video experiences.

21. A method comprising:
providing a first system;
providing a digital multimedia stream including at least one of audio and video data to the first system;
providing information relating to the digital multimedia stream on the first system, the information in the form of at least one of audio and video presentation; and,
determining quality metric data relating to the display of the digital multimedia stream on the first system, the quality metric data related to user provided quality metric data, the user provided quality metric data provided for indicating an effect on a quality of a presentation in response to at least one of known problems with at least one of the first system and known errors within the data stream.

22. A method according to claim 21 comprising:
transmitting the quality metric data from the first system to an aggregation server; and
storing the quality metric data within the aggregation server.

23. A method according to claim 21 wherein the quality metric data is stored within the first system.

24. A method according to claim 21 wherein the quality metric data is provided from the first system.

25. A method according to claim 21 wherein the quality metric data comprises a measure of the quality of experience (QoE) of a user experiencing the presentation.

26. A method according to claim 25 comprising:
providing mapping data indicative of a level of defect sensitivity of QoE for the data stream when presented;
determining defects within the data stream when presented; and,
mapping the detected defects to determine a QoE measure for the data stream.

27. A method according to claim 26 wherein determining comprises determining during data stream presentation a number and classification of defects occurring during the presentation whether present within the received data stream or having other causes.

28. A method according to claim 27 wherein the mapping data is formed by statistically correlating user evaluation data relating to viewing of data streams on systems, at least one of the systems and the data streams having known causes of defects within presented audio/video experiences.
